(19) United States
(12) Patent Application Publication
(10) Pub. No.: US 2008/0111761 A1
(43) Pub. Date: May 15, 2008

(54) Digital TV Antenna

(75) Inventors: Ching-Neng Kan, Taoyuan County (TW); Hsuan-Yi Kuo, Taoyuan County (TW); Hsien-Chen Dai, Taoyuan County (TW); Yi-Hung Chang, Taoyuan County (TW)

Correspondence Address: WPAT, PC, 7225 BEVERLY ST., ANNANDALE, VA, 22003, US

(73) Assignee: KINSUN INDUSTRIES INC., Taoyuan County (TW)

(21) Appl. No.: 11/675,702

(22) Filed: Feb. 16, 2007

(30) Foreign Application Priority Data
Nov. 9, 2006 (TW) 095219781

(51) Int. Cl. H01Q 1/40; H04L 27/00

(52) U.S. Cl. 343/873; 375/316

(57) ABSTRACT

A digital TV antenna, comprising an antenna cable in a copper tube covered by a plastic coating as an antenna housing, wherein a top end of the digital TV antenna is used as a feed-in terminal of the antenna cable extended to a connector at the other end for electric connection to an external electronic appliance.

### BACKGROUND OF THE INVENTION

1. Field of the Invention

The present invention generally relates to a digital TV antenna and, more particularly, to an antenna using a copper tube in a main structure so as to improve the frequency response especially at low frequencies. The digital TV antenna of the present invention has advantages in reliable transceiving, wider band-width, and compactness.

2. Description of the Prior Art

Antennas are widely used in wireless communication and dominate over other components in transceiving quality that is strongly determined by the structures of the antennas. In Taiwan Patent Publication No. M290618 “Compact antenna for digital broadcasting”, a first antenna and a second antenna are connected so as to minimize the antenna length. However, the first antenna and the second antenna are both spiral to have problems such as:

1) unreliability in signal receiving: the length of spiral antennas is often varied due to elastic fatique after long usage so that the frequency response is varied;

2) narrower band-width: spiral antennas are low-cost and easy to manufacture but the band-width is relatively narrower; and

3) limited length reduction: spiral antennas are designed to be longer for lower frequency applications.

In order to overcome the foregoing problems, there is need in providing a digital TV antenna using a copper tube in a main structure so as to improve the frequency response especially at low frequencies.

### SUMMARY OF THE INVENTION

It is a primary object of the present invention to provide a digital TV antenna using a copper tube instead of a spiral coil in a main structure so as to have advantages in reliable transceiving, wider band-width, and compactness.

It is a secondary object of the present invention to provide a digital TV antenna that can be used in applications such as digital video broadcasting (DVBT)/ultra high frequency (UHF) at 474˜860 MHz.

In order to achieve the foregoing objects, the present invention provides a digital TV antenna, comprising an antenna cable in a copper tube covered by a plastic coating as an antenna housing, wherein a top end of the digital TV antenna is used as a feed-in terminal of the antenna cable extended to a connector at the other end for electric connection to an external electronic appliance.

### BRIEF DESCRIPTION OF THE DRAWINGS

The objects, spirits and advantages of the preferred embodiment of the present invention will be readily understood by the accompanying drawings and detailed descriptions, wherein:

FIG. 1 is a side view of a digital TV antenna according to the present invention; and

FIG. 2 is a cross-sectional view of the digital TV antenna in FIG. 1.

### DETAILED DESCRIPTION OF THE PREFERRED EMBODIMENT

The present invention providing a digital TV antenna can be exemplified by the preferred embodiment as described hereinafter.

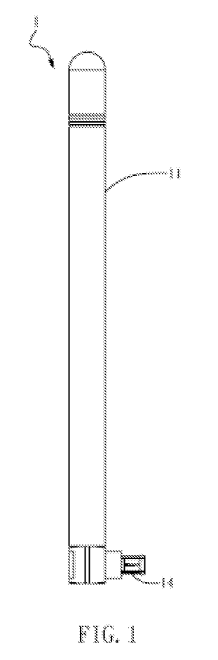

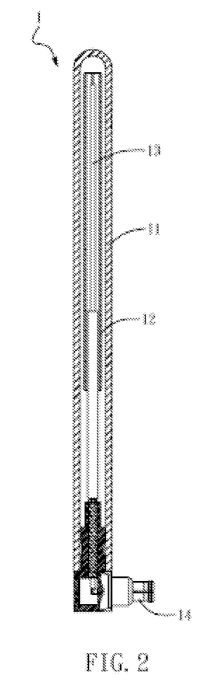

Please refer to FIG. 1 and FIG. 2 for a side view and a cross-sectional view, respectively, of a digital TV antenna according to the present invention. The digital TV antenna 1 comprises an antenna cable 13 in a copper tube 12 covered by a plastic coating as an antenna housing 11. A top end of the digital TV antenna 1 is used as a feed-in terminal of the antenna cable 13 extended to a connector 14 at the other end for electric connection to an external electronic appliance. The length of the digital TV antenna 1 of the present invention can be reduced and thus problems of conventional spiral antennas can be prevented.

In the present embodiment, the antenna cable 13 is a co-axial wire.

The digital TV antenna 1 of the present invention can be used in applications such as digital video broadcasting (DVBT)/ultra high frequency (UHF) at 474˜860 MHz. However, the present invention is not limited to DVBT/UHF, and any application at 474˜860 MHz is within the scope of the present invention.

With reference to the disclosure in FIG. 1 and FIG. 2, the digital TV antenna of the present invention has advantages such as:

1) improved reliability in signal receiving: the length of the copper tube is fixed and thus the antenna is free of problems due to elastic fatique after long usage so that the frequency response is stable;

2) wider band-width: the copper tube is hollow inside and thus provides a wider band-width than the conventional spiral antenna; and

3) reduction in length of the antenna: the copper tube antenna has a wider band-width so that the length of the copper tube can be reduced; and

4) enhanced gain: the copper tube has a hollow portion for electromagnetic resonance to enhance the gain.

According to the above discussion, it is apparent that the present invention discloses a digital TV antenna using a copper tube in a main structure so as to improve the frequency response especially at low frequencies. Therefore, the present invention is novel, useful and non-obvious.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A digital TV antenna, comprising an antenna cable in a copper tube covered by a plastic coating as an antenna housing, wherein a top end of the digital TV antenna is used as a feed-in terminal of the antenna cable extended to a connector at the other end for electric connection to an external electronic appliance.

2. The digital TV antenna as recited in claim 1, wherein the digital TV antenna can be used in applications such as digital video broadcasting (DVBT)/ultra high frequency (UHF) at 474˜860 MHz.

3. The digital TV antenna as recited in claim 1, wherein the antenna cable is a co-axial wire.
